(19) United States
(12) Patent Application Publication
(10) Pub. No.: US 2011/0066417 A1
(43) Pub. Date: Mar. 17, 2011

(54) ELECTRONIC LOAD FOR SIMULATING CHARACTERISTICS OF AN LED AND METHOD FOR OPERATING THE SAME

(75) Inventors: MING-YING TSOU, TAIPEI CITY (TW); YI-CHIAO CHENG, TAIPEI COUNTY (TW); WEN-CHUNG CHEN, TAIPEI COUNTY (TW); REN-KAI CHEN, TAIPEI COUNTY (TW); CHANG-CHENG SU, TAIPEI COUNTY (TW)

(73) Assignee: CHROMA ATE INC., TAO-YUAN HSIEN (TW)

(21) Appl. No.: 12/725,790

(22) Filed: Mar. 17, 2010

(30) Foreign Application Priority Data
Sep. 11, 2009 (TW) 098130654

(51) Int. Cl. G06G 7/62

(52) U.S. Cl. 703/13

(57) ABSTRACT

An electronic load simulates an LED is to output a simulation signal after receiving an input signal. The simulation signal has a voltage value and a current value approximating to a characteristic curve of a real LED. The electronic load comprises a processor, an amplifier, and a control unit. The processor receives a control command to set up the LED. The control command includes a forward voltage parameter and an equivalent impedance parameter. The control unit generates an adjustment command according to the foregoing parameters and the voltage of the power source. The amplifier receives and further adjusts the adjustment command so as to output the simulation signal.

This application claims the benefit of Taiwan Patent Application Serial No. 098130654, filed Sep. 11, 2009, the subject matter of which is incorporated herein by reference.

### BACKGROUND OF THE INVENTION

(1) Field of the Invention

The invention relates to an electronic load and the method for operating the electronic load, and more particularly to the electronic load that is capable of simulating characteristics of a light emitting diode (LED).

(2) Description of the Prior Art

The LED is featured in high conversion efficiency, short reaction time, high glimmer frequency, energy-saving, etc. In fact, the LED has taken over various traditional lighting equipments such as tungsten lamps, fluorescent lamps and so on. For the voltage-current characteristics of the LEDs are much different from those of the traditional lighting equipments, power sources for those traditional lighting equipments can't be directly applied to the LEDs.

In the art, the testing upon an LED power source usually uses a real LED. However, the voltage-current characteristics of LEDs vary to some extents, particularly with the materials. Besides, individual manufacturers may have different standards for the LED, by which characteristic differences among LEDs in the marketplace can be foreseen. Further, the impedance of the LED is dependent on the temperature, the service time, and some external factors. Owing to the facts mentioned above, using a real LED as a device for testing a prospective power source is unable to justify the testing of simulation results.

In electronic industry, though various electronic loads are available in simulating respective electronic elements, yet there is no such electronic load for simulating an LED. In the past, the operator usually uses a constant-resistance (CR) mode electronic load to generate a straight line having a slope m in the voltage-current plot, and adjust the slope to approximate the LED characteristic curve.

Refer now to FIG. 1 for a typical simulation of a CR mode electronic load, in which the CR mode electronic load outputs a straight line S1 with a slope m, while the characteristic curve S2 is the curve of a real LED. As shown, the line S1 is straight from the origin, but the characteristic curve S2 is close to horizontal after leaving the origin and goes vertically up quickly after a little progress in the voltage-current plot. The local slope of the characteristic curve S2 is equal to the instant impedance of the LED at the local point in the plot. Obviously, the constant slope in the CR mode electronic load (S1) cannot map appropriately the varying slopes in the LED characteristic curve (S2). Therefore, inaccuracy in testing upon using the CR mode electronic load can be expected.

### SUMMARY OF THE INVENTION

It is an object of the present invention to provide an electronic load capable of simulating signals having a voltage value and a current value approximating to a characteristic curve of an LED at any moment, so as to substantially simulate a real LED can do.

In this invention, the electronic load is powered by a power source, and receives an input signal. The electronic load comprises a processor, an amplifier, a voltage measurement unit, and a control unit. The processor further includes a parameter control unit.

The parameter control unit electronically couples with the control unit. The control unit electronically couples between the voltage measurement unit and the amplifier. The voltage measurement unit electronically couples with the power source so as able to measure/monitor the voltage of the input signal.

The control unit further includes a forward voltage processor and an equivalent impedance processor. The parameter control unit further includes a forward voltage controller and an equivalent impedance controller. The forward voltage controller electronically couples with the forward voltage processor, and the equivalent impedance controller electronically couples with the equivalent impedance processor.

The electronic load receives a set of control commands or parameters, including a forward voltage parameter and an equivalent impedance parameter. The forward voltage processor and the equivalent impedance processor receive the parameters to generate an adjustment command, and forward the adjustment command to the amplifier.

The amplifier adjusts/magnifies the input signal, according to the adjustment command, so as to convert it into a corresponding simulation signal to output therefrom, and further to trigger the power source outputting a power to the electronic load according to the simulation signal.

The forward voltage of the simulation signal equals to the forward voltage parameter, and the slope of the simulation signal in the voltage-current plot equals to the equivalent impedance parameter. As a result, the simulation signal would better present the characteristics of a real LED.

By importing different control commands, this electronic load would output the simulation signal in accordance with the control command. Hence, this invention of the electronic load can simulate different LEDs.

All these objects are achieved by the electronic load described below.

### BRIEF DESCRIPTION OF THE DRAWINGS

The present invention will be specified with reference to its preferred embodiment illustrated in the drawings, in which:

FIG. 1 is a schematic plot to present a conventional CR mode electronic load;

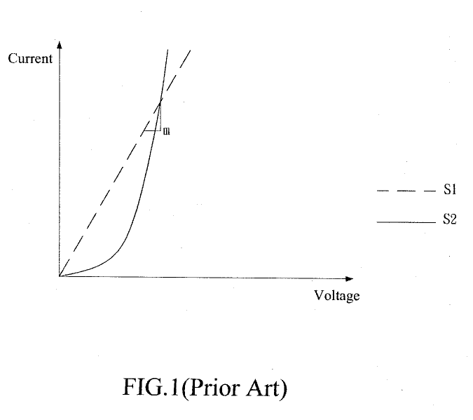

FIG. 2 shows a schematic view of the equivalent impedance of the LED;

FIG. 3 is a schematic view of a first embodiment of the electronic load in accordance with the present invention;

FIG. 4 shows a schematic view of a second embodiment of the electronic load in accordance with the present invention;

FIG. 5 is a schematic plot showing simulation results of the electronic load in accordance with the present invention; and

FIG. 6 shows a flow chart of the simulation method to operate the electronic load in accordance with the present invention.

### DESCRIPTION OF THE PREFERRED EMBODIMENT

The invention disclosed herein is directed to an electronic load for simulating characteristics of an LED and the method for operating the electronic load. In the following description, numerous details are set forth in order to provide a thorough understanding of the present invention. It will be appreciated by one skilled in the art that variations of these specific details are possible while still achieving the results of the present invention. Under such a circumstance, there are two preferred embodiments described herein applied for the embodiment is provided to illustrate the present invention in details.

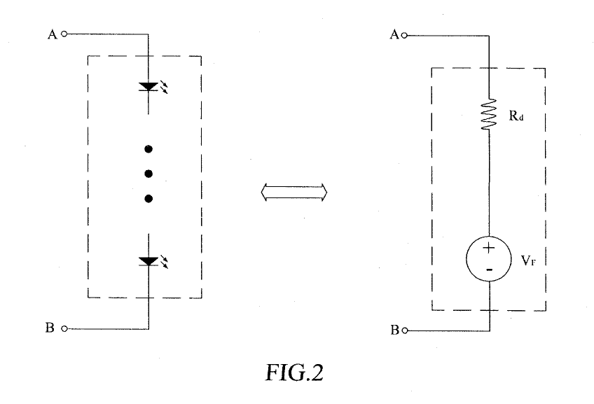

Please refer now to FIG. 2, in which the equivalent impedance of a LED string to the conventional circuit is shown. The illustration at the left in FIG. 2 is the sketch of the LED string, a series of LEDs, which is electrically equivalent to the illustration at the right in FIG. 2. That is to say that the LED string can be equivalently functioned as an in-serial combination of a resistance R_{d} and a voltage source V_{F}. The magnitude of the resistance R_{d} is the equivalent impedance of the LED string, and the magnitude of the voltage source V_{F} is the equivalent forward voltage of the LED string.

As long as the LED string can be successfully simplified as the aforesaid combination of the resistance and the voltage source, the characteristic curve of the LED string in a voltage-current plot can be obtained.

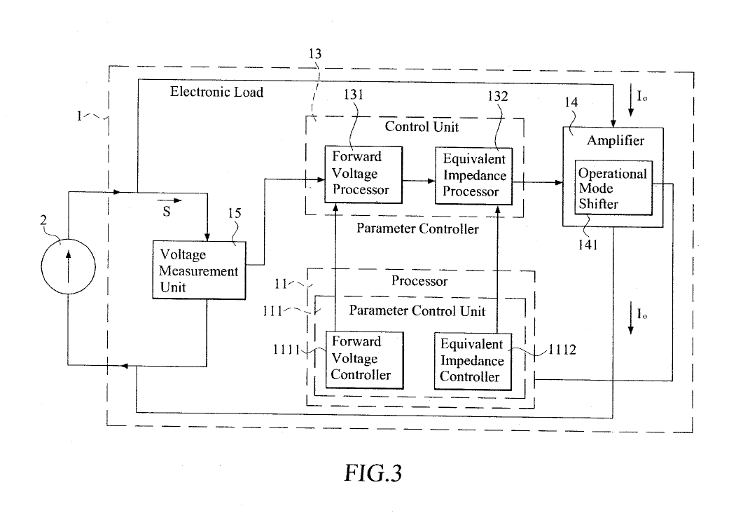

Please refer now to FIG. 3, in which a schematic view of a first embodiment of the electronic load in accordance with the present invention is shown. The electronic load 1 powered by a power source 2 is to receive an input signal S and output a simulation signal I_{O}.

The electronic load 1 comprises a processor 11, a control unit 13, an amplifier 14, and a voltage measurement unit 15. The processor 11 further includes a parameter control unit 111. The parameter control unit 111 further includes a forward voltage controller 1111 and an equivalent impedance controller 1112. The control unit 13 further includes a forward voltage processor 131 and an equivalent impedance processor 132.

The forward voltage processor 131 electronically couples among the forward voltage controller 1111, the equivalent impedance processor 132 and the voltage measurement unit 15 connected with the power source 2. The equivalent impedance processor 132 electronically couples among the forward voltage processor 131, the equivalent impedance controller 1112 and the amplifier 14. The amplifier 14 contains an operational mode shifter 141 connected with the processor 11, which can make the simulation of the electronic load more accurate by determining the level of the input signal S.

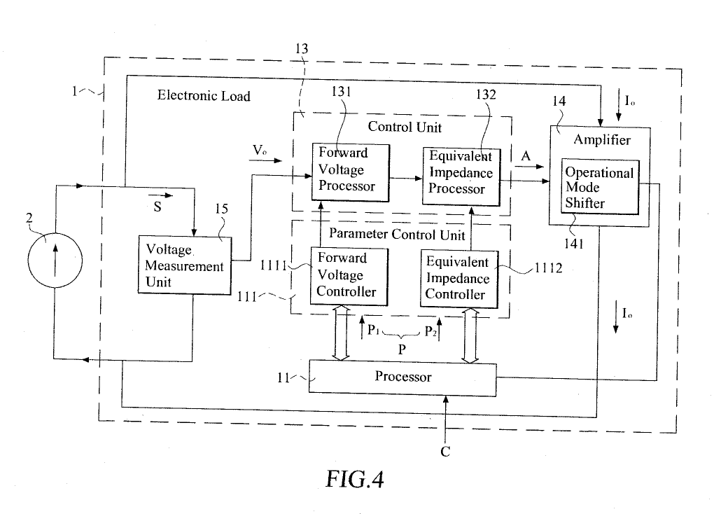

Please refer to FIG. 4, in which a schematic view of a second embodiment of the electronic load in accordance with the present invention is shown. The major difference between the first embodiment of FIG. 3 and this second embodiment of FIG. 4 is that the parameter control unit 111 is discrete from the processor 11, as shown in FIG. 4.

In simulation, the power source 2 generates the input signal S to the voltage measurement unit 15. The voltage measurement unit 15 measures the voltage of the input signal S to generate a measurement Vₒ. The measurement Vₒ is then passed to the forward voltage processor 131. At the same time, the electronic load 1 receives the control command C for setting specifications of an LED device to be simulated.

The control unit 13 decodes the control command C and generates accordingly at least a set of the parameters P. The set of the parameters P further includes a forward voltage parameter P1 and an equivalent impedance parameter P2. The forward voltage parameter P1 is to set up the forward voltage of the simulation signal I_{O}. The equivalent impedance parameter P2 is to set up the equivalent impedance of the simulation signal I_{O}, which also equals to the resistance R_{d} in FIG. 2.

It is always true that the input voltage equals to the output voltage of a circuit (i.e., Vₒ=V_{F}+I_{O}×R_{d}). In the case that the measurement Vₒ is less than the magnitude of the forward voltage source V_{F} (also called voltage source), the amplifier 14 won't work. In the case that the measurement Vₒ is larger in magnitude than the voltage source V_{F}, the forward voltage processor 131 begins calculating the voltage deviation between the measurement Vₒ and the voltage source V_{F}. Theoretically, the voltage deviation equals to the current of the simulation signal I_{O} multiplying the magnitude of the resistance R_{d}. The inverse of the resistance R_{d} is the slope of the characteristic curve in the aforesaid voltage-current plot.

The forward voltage processor 131 generates an adjustment command A according to the measurement Vₒ and the set of the parameters P. The amplifier 14 adjusts the output according to the adjustment command A.

For instance, the measurement Vₒ of the power source is 4.5V, and it is expected to have the electronic load simulate an LED with a 3V forward voltage and a 5 S2 equivalent impedance. According to a control command C, the processor 11 generates a corresponding forward voltage parameter P1 of 3 and a corresponding equivalent impedance parameter P2 of 50 after decoding the control command C.

In the present invention, the electronic load 1 can further include a built-in database. The database stores LED types, LED characteristics, connection conditions, etc. Information of a particular LED to be simulated can be loaded from the database so as to generate the adjustment command A according to the information.

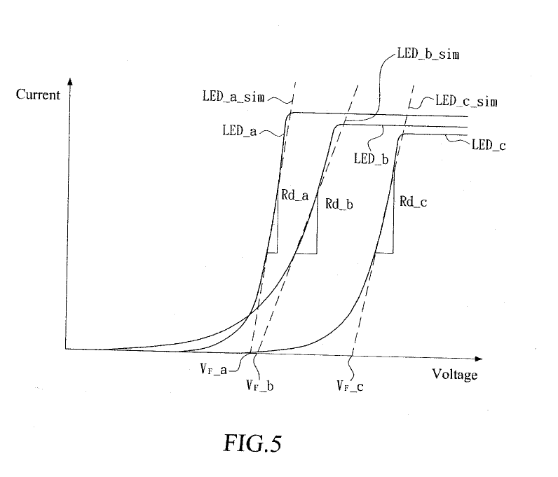

Please refer to FIG. 5, which shows a schematic view of simulations of the electronic load of FIG. 3 in the present invention. Three different characteristic curves are included: an LED_a with a forward voltage V_{F}_{_{—}}ₐ, an LED_b with a forward voltage V_{F}_{_{—}}_{b}, and an LED_c with an forward voltage V_{F}_{_{—}}_{c}. Equivalent impedances for the three aforesaid simulations (three characteristic curves) are R_{d}_{_{—}}ₐ, R_{d}_{_{—}}_{b}, and R_{d}_{_{—}}_{c}, respectively. The simulation signals outputting from the electronic load are LED_a_sim, LED_b_sim, and LED_c_sim, respectively as shown.

In the case that the LED with the characteristic curve LED_a is to be simulated, a control command C with parameters V_{F}_{_{—}}ₐ and R_{d}_{_{—}}ₐ can be introduced. Namely, by simulating the LED_a_sim in the electronic load, the outputs results can pretty much map the real characteristic curves LED_a.

The simulation upon an LED combination with plural LEDs, serially or parallel, can also be carried out in the electronic load of the present invention by utilizing equivalent forward voltage and impedance.

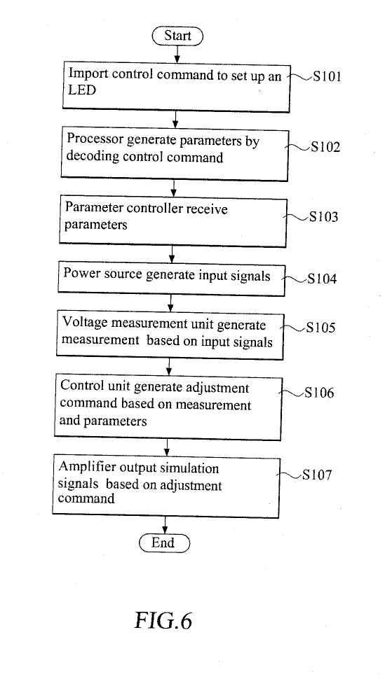

Please refer to FIG. 6, which shows a flow chart of the simulation method for simulating the LED characteristics in accordance with the present invention. The steps are described as follows.

Firstly, the control command for setting up the specification of the LED to be simulated is imported to the electronic load. (S101)

Secondly, the processor inside the electronic load generates at least one set of parameters by decoding the control command. (S102)

Thirdly, the parameter control unit inside the electronic load receives the set of the parameters. (S103)

Fourthly, the power source generates an input signal to the electronic load. (S104)

Fifthly, the voltage measurement unit generates a measurement by measuring the voltage of the input signal. (S105)

Sixthly, the control unit generates an adjustment command by calculating the set of the parameters and the measurement. (S106)

Finally, the amplifier outputs the simulation signal based on the adjustment command to trigger the power source outputting a power to the electronic load according to the simulation signal. (S107)

This electronic load is capable of adjusting the magnitude of the equivalent impedance to conform a real current simulation. Furthermore, this electronic load is also capable of setting up the initial impedance so as to avoid possible voltage surge in the simulation.

While the present invention has been particularly shown and described with reference to a preferred embodiment, it will be understood by those skilled in the art that various changes in form and detail may be without departing from the spirit and scope of the present invention.

I claim:

1. An electronic load to simulate an LED, receiving an input signal from an power source, and outputting a simulation signal having a voltage value and a current value approximating to a characteristic curve of the LED at any moment to trigger the power source outputting a power to the electronic load according to the simulation signal, and the electronic load comprising:
a processor for receiving a set of control commands including a set of parameters and further forwarding said set of parameters to a parameter control unit;
a voltage measurement unit for generating at least one measurement by measuring a voltage of the input signal; and
a control unit, electrically coupled with the parameter control unit and the voltage measurement unit, for generating an adjustment command by calculating said set of parameters and the measurement and further forwarding the adjustment command to an amplifier, and the amplifier outputting the simulation signal based on the adjust command.

2. The electronic load according to claim 1, wherein said set of the parameters further includes a forward voltage parameter and an equivalent impedance parameter.

3. The electronic load according to claim 1, wherein said parameter control unit further includes:
a forward voltage controller for receiving a forward voltage parameter of said set of parameters to set up a forward voltage of said simulation signal; and
an equivalent impedance controller for receiving an equivalent impedance parameter of said set of parameters to set up an equivalent impedance of said simulation signal.

4. The electronic load according to claim 3, wherein said control unit further includes:
a forward voltage processor for receiving said forward voltage parameter and said measurement; and
an equivalent impedance processor for receiving said equivalent impedance parameter and said measurement;
wherein said adjustment command is generated by the forward voltage processor and the equivalent impedance processor.

5. An electronic load to simulate an LED, receiving an input signal from a power source, and outputting a simulation signal having a voltage value and a current value approximating to a characteristic curve of the LED at any moment to trigger the power source outputting a power to the electronic load according to the simulation signal, and the electronic load comprising:
a parameter control unit for receiving a set of parameters for setting up the simulation signal;
a control unit, electrically coupled with the parameter control unit, for generating an adjustment command by calculating said set of parameters and the measurement and further forwarding the adjustment command to an amplifier, and the amplifier outputting the simulation signal based on the adjust command.

6. The electronic load according to the claim 5, wherein said parameter control unit further includes:
a forward voltage controller for receiving a forward voltage parameter of said set of parameters to set up a forward voltage of said simulation signal; and
an equivalent impedance controller for receiving an equivalent impedance parameter of said set of parameters to set up an equivalent impedance of said simulation signal.

7. A simulation method for simulating LED characteristics applied to an electronic load which is electrically coupled with a power source, to output a simulation signal having a voltage value and a current value approximating to a working characteristic curve of the LED at any moment to trigger the power source outputting a power to the electronic load according to the simulation signal, the simulation method comprising the steps of:
(a) inputting a control command to the electronic load;
(b) a processor inside of the electronic load generating at least one set of parameters by decoding the control command;
(c) a parameter control unit inside the electronic load receiving the set of parameters;
(d) the power source generating an input signal to the electronic load;
(e) a parameter measurement unit generating a measurement by measuring a voltage of the input signal;
(f) a control unit generating an adjustment command by calculating the set of parameters and the measurement; and
(g) an amplifier outputting the simulation signal based on the adjustment command.

8. The simulation method according to claim 7, wherein said set of parameters further includes:
a forward voltage parameter for setting up a forward voltage of said simulation signal; and
an equivalent impedance parameter for setting up an equivalent impedance of said simulation signal.
